(19) United States
(12) Patent Application Publication
(10) Pub. No.: US 2008/0189591 A1
(43) Pub. Date: Aug. 7, 2008

(54) METHOD AND SYSTEM FOR GENERATING A MEDIA PRESENTATION

(76) Inventor: David B. Lection, Raleigh, NC (US)

Correspondence Address: SCENERA RESEARCH, LLC, 111 CORNING RD., SUITE 220, CARY, NC, 27511, US

(21) Appl. No.: 11/669,603

(22) Filed: Jan. 31, 2007

(51) Int. Cl. G06F 15/00; G06F 17/00; G06F 3/00

(52) U.S. Cl. 715/202; 715/731

(57) ABSTRACT

Methods and systems are described for generating a media presentation. In one embodiment, the method includes receiving first media selection criteria associated with a media presentation for identifying a characteristic of media to be included in the media presentation. The method also includes retrieving a first set of media objects according to the first media selection criteria. The method further includes generating second media selection criteria from metadata associated with the first set of media objects. The method still further includes retrieving a second set of media objects according to the second media selection criteria. The method includes receiving presentation information defining a format for the media presentation.

### BACKGROUND

Computer users today collect lots of media in the form of photographs, video, music, text oriented media, and documents. Most all of this media is tagged or labeled with one or more dates which indicate when the media was created, modified, or the date applies to the context of the media. For example, while media may be created on a certain date, the subject matter of the media can imply a different contextual date. Internet sites also collect media in the form of images, videos, blogs, news information and other media. Those media objects are also tagged with one more dates that apply to the creation, modification, or context dates of the objects.

Users today manually create media presentations including a variety of media they have collected. These presentations include, for example, slideshows of a variety of images. Combining media of differing types gives the user a rich multimedia way to experience the media, resulting in a “sum is greater than the parts” experience. A slideshow with an accompanying music track is an example of a multimedia presentation that is typically manually created by today's computer users. Such existing multimedia presentations are manually created without any intelligent combination of media for presentation.

Accordingly, there exists a need for methods, systems, and computer program products for generating a media presentation.

### SUMMARY

Methods and systems are described for generating a media presentation. In one embodiment, the method includes receiving first media selection criteria associated with a media presentation for identifying a characteristic of media to be included in the media presentation. The method also includes retrieving a first set of media objects according to the first media selection criteria. The method further includes generating second media selection criteria from metadata associated with the first set of media objects. The method still further includes retrieving a second set of media objects according to the second media selection criteria. The method includes receiving presentation information defining a format for the media presentation.

According to another aspect, a system for generating a media presentation is described. The system includes an application controller component configured for receiving first media selection criteria associated with a media presentation for identifying a characteristic of media to be included in the media presentation. The system further includes a media retriever component configured for retrieving a first set of media objects according to the first media selection criteria. The system still further includes a criteria generator component configured for generating second media selection criteria from metadata associated with the first set of media objects, wherein the media retriever component is configured for retrieving a second set of media objects according to the second media selection criteria. The system also includes a presentation assembler component configured for receiving presentation information defining a format for the media presentation and generating the media presentation according to the format using a media object from the second set of media object

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for generating a media presentation according to another embodiment of the subject matter described herein

FIG. 2 is a block diagram illustrating a system for generating a media presentation according to an embodiment of the subject matter described herein;

FIG. 3 is a block diagram illustrating a user interface for specifying the first search criteria when generating a media presentation according to an embodiment of the subject matter described herein;

FIG. 4 is a block diagram illustrating a user interface for specifying the second search criteria when generating a media presentation according to an embodiment of the subject matter described herein; and

FIG. 5 is a block diagram illustrating a user interface for generating a media presentation according to an embodiment of the subject matter described herein.

### DETAILED DESCRIPTION

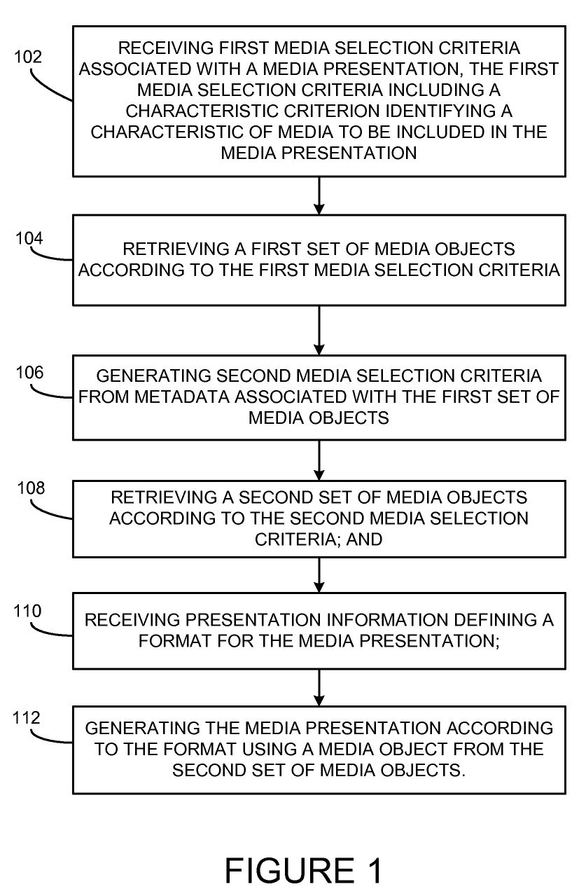

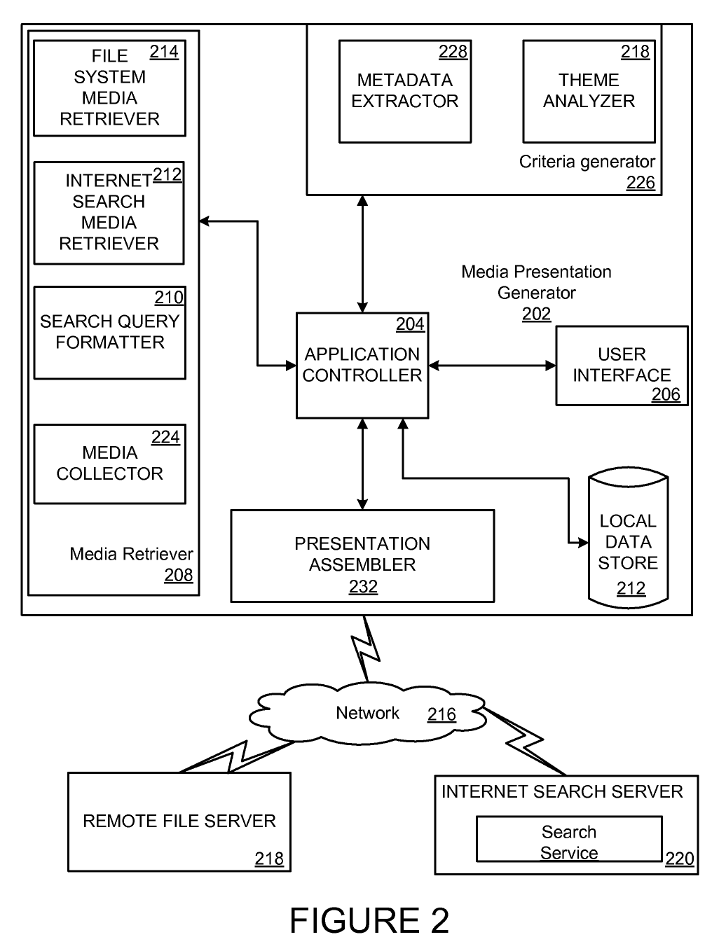

FIG. 1 is a flow diagram illustrating a method for generating a media presentation according to an exemplary embodiment of the subject matter described herein. FIG. 2 is a block diagram illustrating a system for generating a media presentation according to another exemplary embodiment of the subject matter described herein. The method illustrated in FIG. 1 can be carried out by, for example, some or all of the components illustrated in the exemplary system of FIG. 2.

With reference to FIG. 1, in block 102 the method includes receiving first media selection criteria associated with a media presentation for identifying a characteristic of media to be included in the media presentation. Accordingly, a system for generating a media presentation includes means for receiving first media selection criteria associated with a media presentation for identifying a characteristic of media to be included in the media presentation. For example, as illustrated in FIG. 2, an application controller component 204 is configured for receiving first media selection criteria associated with a media presentation for identifying a characteristic of media to be included in the media presentation.

FIG. 2 illustrates an exemplary system including a media presentation generator application 202. The media presentation generator application 202 is, in an embodiment, a client application executing on a user's personal computer. The application may also be hosted on a remote web server or other remote device. The media presentation generator includes the application controller component 204. The application controller component 204 includes the central logic and control system of the application 202. The application controller component 204 calls all of the other components in the application, passing and receiving data from each component as explained in the embodiments below.

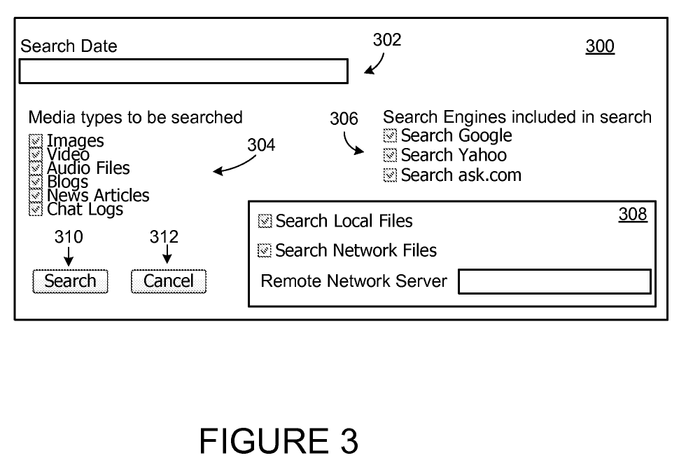

When the application 202 is invoked, the application controller component 204 calls the user interface component 206 to present a user interface. FIGS. 3-5 illustrate various portions of an exemplary user interface 300, 400, 500 presented by user interface component 206. The user enters first media selection criteria associated with a media presentation for identifying a characteristic of media to be included in the media presentation. For example, the user may enter a first search selection expression in a text entry field 302 as media selection criteria. Expressions entered into this field can include a discrete date, e.g. “Jan. 24, 1989,” or a range of dates, e.g. “Jan. 15-30, 1984,” a holiday specification, e.g. “Christmas 1972,” or a holiday range “Thanksgiving 1974-1979”. These date expressions are a representative list, and other date expressions can be supported. The media selection criteria are received by the application controller component 204 from the user interface component 206 in the illustrated embodiment. Further, the user may select the types of media to be searched and retrieved as media selection criteria. For example, the user may specify the type of media to be searched in a media type selection area 304. Any type of media may be supported and the list of media included is a representative sample.

The user may specify where to search for the media. The user may request a search of local files, remote files, and/or which Internet search engines to use to search for media. For example, the user may specify the location in which to search in a file selection area 308 or the Internet search engine to use in a search engine selection area 306. Multiple local and remote drives accessible to the application 202 may be searched. Upon actuation of the search button 310, the user interface component 206 returns the received media selection criteria to the application controller 204.

Returning to FIG. 1, in block 104 the method includes retrieving a first set of media objects according to the first media selection criteria. Accordingly, a system for generating a media presentation includes means for retrieving a first set of media objects according to the first media selection criteria. For example, as illustrated in FIG. 2, a media retriever component 208 is configured for retrieving a first set of media objects according to the first media selection criteria.

Once the user presses the search button 310 of the presented user interface portion 300, the first search is invoked. The application controller 204 calls the media retriever component 208 to retrieve a first set of media objects. The media retriever component 208 may use a search query formatter component 210 to construct a search query for each local and remote file system and each Internet search engine. For the Internet search engines, each query follows a syntax that is acceptable and optimal for the search engine. For example a search of images available on GOOGLE™ for “Christmas 1972” could be formatted as follows:
http://images.google.com/images?hl=en&q=christmas+1972&btnG=Search+Images

If a user specifies a date expression that includes a date that occurs in the future, the application controller component 204 can store the search expression in a local data store component 212 for later retrieval. An operating system on the computer is called to schedule the application 202 to run the day after the latest date in the date expression, and the application 202 is terminated. The operating system, upon reaching the schedule date, will invoke the application 202 that day, preloaded with the first search expression.

For each media type to be retrieved, as specified above, a separate search may be invoked. In an aspect, the media retriever component 208 includes a file system media retriever component 214 configured for searching for media objects in local storage to be included in the media presentation using the generated search query. In another aspect, the file system media retriever component 214 can be configured for searching for media objects in remote file-system storage to be included in the media presentation.

The media presentation generator 202 is connected through network 216 to a remote file server 218 and an internet search server 220. These remote servers may include media that can be retrieved by the application 202. In another aspect, the media retriever component 208 includes an Internet search media retriever component 222 configured for searching for media objects using the generated search query in an Internet search engine. The Internet search media retriever component 222 is configured to call the Internet search engine and receive, from the search engine, a list of uniform resource locators (URLs) representing media found in the search that conforms to the search expression.

Regardless of where the media is searched for, the media retriever component 208 returns a list of media to the application controller 204, and the application controller 204 calls the media collector component 224 to add the list of media URL's to the first media search list. This list is stored on the local data store component 212.

Application controller 204 maintains a pointer to the first media search list in the local data store component 212 for later use. For example, if the user enters the date “Christmas 1972” and performs a search, then any media with “Christmas” and “1972” in the filename,in text within the media, or in metadata in the media will be added to the first search list of media. In the example, the first search will find several images of the user's family that were taken on Christmas in 1972.

Returning to FIG. 1, in block 106 the method includes generating second media selection criteria from metadata associated with the first set of media objects. Accordingly, a system for generating a media presentation includes means for generating second media selection criteria from metadata associated with the first set of media objects. For example, as illustrated in FIG. 2, a criteria generator component 226 is configured for generating second media selection criteria from metadata associated with the first set of media objects.

The criteria generator component 226 extracts the metadata associated with the first set of media objects to analyze the metadata for themes. The application controller component 204 calls the metadata extractor component 228, passing the pointer to the first search media list. The metadata extractor 228 retrieves each media object in the media list and analyzes the media object for metadata. For example, textual metadata strings can be extracted from the media objects. The metadata strings can include phrases that are at least one word in length. These phrases are extracted from the filename of the media objects, from the contents of the media objects, or from metadata occurring within the media objects. Once all media objects in the list have been analyzed, the media extractor component 228 returns the list of metadata strings to the application controller component 204.

The application controller component 204 calls the theme analyzer component 218, passing to the theme analyzer component 218 the list of metadata strings. The theme analyzer component 218 sorts the strings and analyzes them for reoccurring patterns. This is done, for example, by extracting phrases in strings and by counting the occurrences of each phrase. Popular phrases will have the most number of occurrences. The most popular reoccurring patterns can be saved in a list for the user in the data store component 212.

In another aspect, the theme analyzer component 218 can be configured for grouping the reoccurring metadata into a theme and presenting the theme. The criteria generator component 226 can be configured for receiving a selection of the theme as the second media selection criteria. In another aspect, the theme analyzer component 218 can be configured for identifying metadata associated with media objects from a previous retrieving of media objects in the metadata associated with the first set of media objects.

For example, a history of past activity by a user may be stored with previous analysis results, such as counting occurrences. When a current analysis is performed, the analysis can be modified based on phrases used in the past. For example, a phrase detected in a current metadata set can be given a higher count or weighting if it has a high past usage. In yet another example, relationships between metadata phrases may be established, for example, by detecting the co-occurrence of two metadata instances across a plurality of media objects and correlating the two metadata instances based on the number of co-occurrences to establish a weighted relationship. Thus, the occurrence of one of the metadata instances may cause a highly correlated second metadata instance to be used in a second search. When the theme analyzer component 218 completes the theme analysis, control is returned to the application controller component 204, along with the list of the most popular themes.

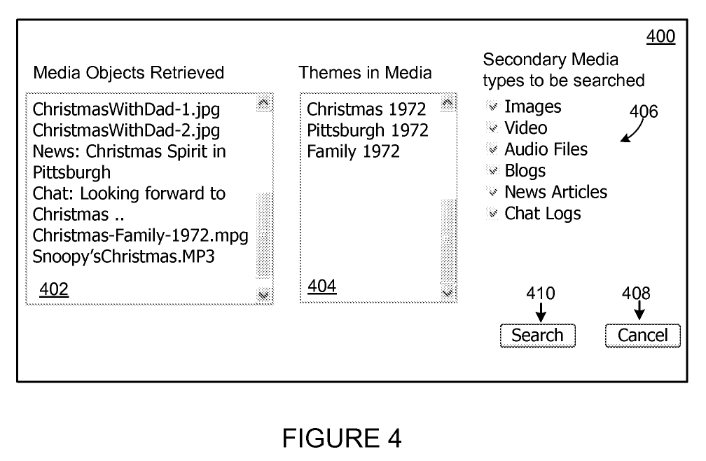

The application controller component 204 can call the user interface component 206 to pass both the pointer to the first search media list, and a pointer to the popular theme list. Using this data, the application controller component 204 calls the user interface component 206, to display the user interface portion 400 shown in FIG. 4 in the described embodiment described.

For example, a media object retrieved area 402 of FIG. 4 displays the list of media objects retrieved during the first search. A theme display area 404 shows the themes extracted from the first search media. The user may select the desired popular theme in the theme display area 404, and the types of additional media to retrieve in a secondary media area 406. The user may then press a search button 410 to perform the second search. In an alternate embodiment, a user interface portion is not presented and the generated second media selection criteria are automatically submitted for search.

Returning to FIG. 1, in block 108 the method includes retrieving a second set of media objects according to the second media selection criteria. Accordingly, a system for generating a media presentation includes means for retrieving a second set of media objects according to the second media selection criteria. For example, as illustrated in FIG. 2, the media retriever component 208 is configured for retrieving a second set of media objects according to the second media selection criteria.

The user interface component 206 returns to the application controller component 204 the second media selection criteria. For example, the second selection criteria returned to the application controller component 204 can include a selected theme and the types of media to be retrieved. For each media type to be retrieved, a separate search may be invoked. The application controller component 204 calls the media retriever component 208 to retrieve media objects similar to the manner in which the first set of media objects is retrieved, as discussed above.

The media retriever component 208 may use the Internet search media retriever 212 to return a list of media to the application controller component 204. The application controller component 204 is configured to invoke the media collector component 224 to add the list of media URLs to the second media search list. This list is stored on the local data store component 212.

The search query formatter component 210 can also format a search string to search local and remote file systems for media that are file-system-accessible. The application controller component 204 may call the file system media retriever component 214 to retrieve media satisfying the search from each local and remote disk. The file system media retriever component 214 can return a list of media to the application controller 204. The application controller can call the media collector component 224 to add the list of media URLs to the second media search list. Again, this list may be stored on the local data store component 212. The application controller component 204 can maintain a pointer to the second media search list in the local data store component 212 for later use.

For example, a user who lives in Pittsburgh, Pa. (Pa.), may search for the event of Christmas, 1972. Media objects can be retrieved and all of the metadata for the retrieved media objects can be analyzed. In the example, three themes are identified: “Christmas 1972,” “Pittsburgh 1972,” and “Family 1972.” The user can select “Pittsburgh 1972” as the second search criteria. A second search is then performed with the second search criteria, resulting in the retrieval of additional media objects related to Pittsburgh in 1972. These media objects can be added to the list of media for the second search.

Returning to FIG. 1, in block 110 the method includes receiving presentation information defining a format for the media presentation. Accordingly, a system for generating a media presentation includes means for receiving presentation information defining a format for the media presentation. For example, as illustrated in FIG. 2, a presentation assembler component 232 is configured for receiving presentation information defining a format for the media presentation.

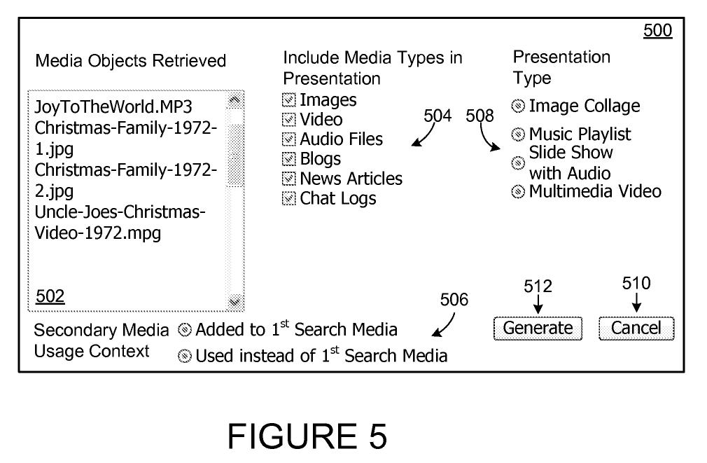

The application controller 204 is configured to call the user interface component 206 to display the user interface portion 500 illustrated in FIG. 5. In a presentation selection area 508, the user specifies the presentation type for the generated presentation. Presentation styles may include, for example, an image collage arranged into a single image, a music play-list that includes a series of music audio files, a slide show with audio formulated from the images and audio files found, or a full multimedia video presentation.

In another aspect, the application controller component 204 can be configured for defining the presentation information by the metadata associated with the second set of media objects. For example, if the second set of media objects includes all images, the presentation information may be automatically an image collage.

Returning to FIG. 1, in block 112 the method includes generating the media presentation according to the format using a media object from the second set of media objects. Accordingly, a system for generating a media presentation includes means for generating the media presentation according to the format using a media object from the second set of media objects. For example, as illustrated in FIG. 2, a presentation assembler component 232 is configured for generating the media presentation according to the format using a media object from the second set of media objects.

In an aspect, the presentation assembler component 232 can be configured for generating the media presentation by generating at least one of an image collage, a slide show, a music presentation, a video presentation, and a multimedia presentation.

The media presentation includes at least one media object from the second set of media objects. In another aspect, the presentation assembler component 232 can be configured for generating the media presentation using a media object from the first set of media objects.

The user interface portion 500 illustrated in FIG. 5 depicts a list of media objects that may be included in a presentation in a media objects area 502. The list of media objects presented in media objects area 502 includes the additional media objects retrieved in the second search, and can also include media objects retrieved in the first search depending on whether an “augment” function is selected (described in greater detail below). The user can select media objects from the second search (and perhaps objects from the first search) to be included in the final presentation from the area 502. The user selects, in a media type selection area 504, the types of media objects retrieved from at least one of the searches to be included in the final presentation.

In an augment selection area 506, the user may specify whether media objects from the second search should augment, that is, be added to the first search media, or whether the media objects retrieved from the second search should replace media objects retrieved in the first search. When the user chooses not to augment media objects retrieved in the first search with those retrieved in the second search, only media objects retrieved in the second search are presented in the media object area 502. When the user chooses to augment media objects retrieved in the first search with those retrieved in the second search, the media object area 502 presents media objects retrieved in the second search along with media objects retrieved in the first search, if not replaced by media objects retrieved in the second search. In an alternate embodiment, this operation is automated based on an analysis of the two sets of retrieved media objects, analogous to the analysis for determining search criteria, as described above.

When the user has selected media objects from the second search, specified how those media objects are to be used, and selected a type of presentation to generate, the user presses the generate button 512 to generate the presentation.

The user interface component 206 returns to the application controller component 204 the list of selected media objects that were retrieved in the second search to be included in the final presentation, the list of types of media objects to be included in the final presentation, the presentation type, and an augment flag to indicate to the presentation assembler component 232 whether to augment the media objects retrieved in the first search with the selected media objects from the second search, or whether the media objects retrieved in the second search should be used instead of the media objects retrieved in the first search.

The application controller component 204 is configured to call the presentation assembler component 232 to create the presentation. In another aspect, the presentation assembler component 232 is configured for generating a master presentation list including media objects from the first set of media objects and from the second set of media objects. The presentation assembler component 232 assembles a master list of media object to be used to generate the presentation. The presentation assembler component 232 checks the presentation type for the kinds of required media. For example an image slide show would include a list of images and one or more audio files as background music. Other presentation types require different kinds of media objects. This list of required media object types is used as part of the media object retrieval process.

The presentation assembler component 232 then retrieves and compiles into a list all of the media objects retrieved in the first search where the type of each selected media object matches a media type in the required media type list. This list is referred to as the first search subset list. The presentation assembler repeats the process of retrieving and compiling into a list the selected media objects retrieved from the second search where the type of the media object is in the list of required media types. This list is referred to as the second search subset list. If the media augment flag has a value of “augment”, then the media objects in the first search subset list and the second search subset list are combined into one list called the master presentation list. If the media augment flag has a value of “replace”, then for each media object in the second search subset list of a given type, a media object from the first list, of the same type is deleted. Then, the remaining objects in the first list, if any, and the media objects in the second list are combined into the master presentation list.

The presentation is generated from the master presentation list of media and written to the local data store component 212 for the user to review. The rendering algorithms used by the presentation assembler component 232 can apply special formatting to certain media object types. For example media objects that are textual in nature, e.g. a news clip, can be rendered to look like a page in a newspaper, including headlines, and other stylistic emphasis.

Completing the example from above, the user can specify whether the objects selected from set of objects retrieved in the second search should augment objects from the first set of retrieved media objects. The images of the user's family from Christmas 1972 can be combined with the images of Pittsburgh from 1972. The user may specify a slide show as the presentation type. The presentation assembler component 232 can use these selected images, along with Christmas music from 1972, to render a slide show with the Christmas music as the audio track and the combined list of images as the video track. The generated presentation can be saved to the local disk of the user's machine.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-including machine, system, apparatus, or device, that can read or fetch the instructions from the machine or computer readable medium and execute the instructions.

As used here, a “computer readable medium” can be any means that can include, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for generating a media presentation, the method comprising:
receiving first media selection criteria associated with a media presentation for identifying a characteristic of media to be included in the media presentation;
retrieving a first set of media objects according to the first media selection criteria;
generating second media selection criteria from metadata associated with the first set of media objects;
retrieving a second set of media objects according to the second media selection criteria;
receiving presentation information defining a format for the media presentation; and
generating the media presentation according to the format using a media object from the second set of media objects.

2. The method of claim 1 wherein the first media selection criteria includes type criterion identifying a type of media to be included in the media presentation.

3. The method of claim 1 wherein the first media selection criteria includes date criterion identifying a date associated with the media to be included in the media presentation.

4. The method of claim 3 wherein retrieving a first set of media objects includes scheduling the first set of media objects to be retrieved according to the date identified by the date criterion when the date is a future date.

5. The method of claim 1 wherein retrieving a first set of media objects includes generating a search query for media objects associated with the first media selection criteria.

6. The method of claim 5 wherein the generated search query is used for searching for media objects in local storage to be included in the media presentation.

7. The method of claim 5 wherein the generated search query is used for searching for media objects in remote storage to be included in the media presentation.

8. The method of claim 5 wherein the generated search query is used for searching for media to be included in the media presentation using an internet search engine.

9. The method of claim 1 wherein generating second media selection criteria includes identifying reoccuring metadata associated with the first set of media objects.

10. The method of claim 9 wherein generating second media selection criteria includes grouping the reoccuring metadata in a theme and presenting the theme, wherein the theme can be selected as the second media selection criteria.

11. The method of claim 1 wherein generating second media selection criteria includes identifying metadata associated with media objects from a previous retrieving of media objects in the metadata associated with the first set of media objects.

12. The method of claim 1 wherein the second media selection criteria includes type criteria identifying a type of media not included in the first set of media objects.

13. The method of claim 1 wherein the presentation information is defined by the metadata associated with the second set of media objects.

14. The method of claim 1 wherein generating the media presentation includes generating at least one of an image collage, a slide show, a music presentation, a video presentation, and a multimedia presentation.

15. The method of claim 1 wherein generating the media presentation includes using a media object from the first set of media objects.

16. The method of claim 1 wherein generating the media presentation includes generating a master presentation list including the media objects to be included in the media presentation, wherein the master presentation list includes media objects from the first set of media objects and from the second set of media objects

17. The method of claim 15 wherein generating the media presentation includes presenting the master presentation list, wherein a media object can be at least one of added to and removed from the master presentation list.

18. system for generating a media presentation, the system comprising:
means for receiving first media selection criteria associated with a media presentation for identifying a characteristic of media to be included in the media presentation;
means for retrieving a first set of media objects according to the first media selection criteria;
means for generating second media selection criteria from metadata associated with the first set of media objects;
means for retrieving a second set of media objects according to the second media selection criteria;
means for receiving presentation information defining a format for the media presentation; and
means for generating the media presentation according to the format using a media object from the second set of media objects.

19. A system for generating a media presentation, the system comprising:
an application controller component configured for receiving first media selection criteria associated with a media presentation for identifying a characteristic of media to be included in the media presentation;
a media retriever component configured for retrieving a first set of media objects according to the first media selection criteria;
a criteria generator component configured for generating second media selection criteria from metadata associated with the first set of media objects, wherein the media retriever component is configured for retrieving a second set of media objects according to the second media selection criteria; and
a presentation assembler component configured for receiving presentation information defining a format for the media presentation and generating the media presentation according to the format using a media object from the second set of media objects.

20. The system of claim 19 wherein the first media selection criteria includes date criterion identifying a date associated with the media to be included in the media presentation.

21. The system of claim 20 wherein the media retriever component is configured for scheduling the first set of media objects to be retrieved according to the date identified by the date criterion.

22. The system of claim 19 comprising a search query formatter component configured for generating a search query for media objects associated with the first media selection criteria.

23. The system of claim 22 wherein the media retriever component includes a file system media retriever component configured for searching for media objects in local storage to be included in the media presentation using the generated search query.

24. The system of claim 22 wherein the media retriever component includes a file system media retriever component configured for searching for media objects in remote storage to be included in the media presentation.

25. The system of claim 22 wherein the media retriever component includes an internet search media retriever component configured for searching for media objects using the generated search query in an internet search engine.

26. The system of claim 19 comprising a theme analyzer component configured for identifying reoccuring metadata associated with the first set of media objects.

27. The system of claim 26 wherein the theme analyzer component is configured for grouping the reoccuring metadata in a theme and presenting the theme, wherein the criteria generator component is configured for receiving a selection of the theme as the second media selection criteria.

28. The system of claim 26 wherein the theme analyzer component is configured for identifying metadata associated with media objects from a previous retrieving of media objects in the metadata associated with the first set of media objects

29. The system of claim 19 wherein the application controller component is configured for defining the presentation information by the metadata associated with the second set of media objects.

30. The system of claim 19 wherein the presentation assembler component is configured for generating the media presentation includes generating at least one of an image collage, a slide show, a music presentation, a video presentation, and a multimedia presentation.

31. The system of claim 19 wherein the presentation assembler component is configured for generating the media presentation includes using a media object from the first set of media objects.

32. The system of claim 19 wherein the presentation assembler is configured for generating a master presentation list including media objects from the first set of media objects and from the second set of media objects.

33. A computer readable medium including a computer program, executable by a machine, for generating a media presentation, the computer program comprising executable instructions for:
receiving first media selection criteria associated with a media presentation for identifying a characteristic of media to be included in the media presentation;
retrieving a first set of media objects according to the first media selection criteria;
generating second media selection criteria from metadata associated with the first set of media objects;
retrieving a second set of media objects according to the second media selection criteria;
receiving presentation information defining a format for the media presentation; and
generating the media presentation according to the format using a media object from the second set of media objects.
